(19) United States
(12) Patent Application Publication
(10) Pub. No.: US 2023/0356154 A1
(43) Pub. Date: Nov. 9, 2023

(54) HOLLOW FIBER MEMBRANE FOR ENCLOSED SPACE AIR REMEDIATION

(71) Applicant: University of Kentucky Research Foundation, Lexington, KY (US)

(72) Inventors: Dibakar Bhattacharyya, Lexington, KY (US); Kevin C. Baldridge, Lexington, KY (US); Kearstin Edmonds, Lexington, KY (US); Rebecca E. Dutch, Lexington, KY (US); J. Zach Hilt, Lexington, KY (US); Thomas Dziubla, Lexington, KY (US); Rollie Mills, Lexington, KY (US)

(21) Appl. No.: 18/142,427

(22) Filed: May 2, 2023

Related U.S. Application Data
(60) Provisional application No. 63/337,663, filed on May 3, 2022.

(51) Int. Cl. B01D 69/02; A62B 11/00; B01D 63/02; B01D 69/14; B01D 53/22; B01D 53/85

(52) U.S. Cl. CPC B01D 69/02; A62B 11/00; B01D 63/02; B01D 69/144; B01D 53/228; B01D 53/85; B01D 2325/48; B01D 2325/02833; B01D 2325/02834; B01D 2325/0283; B01D 2325/04; B01D 2053/224; B01D 2255/804

(57) ABSTRACT

An air remediation device includes a housing including an internal chamber, an inlet, an outlet, and a potting material dividing said internal chamber into a first compartment and a second compartment. At least one hollow fiber membrane is supported by the potting material and held in the first compartment. Airborne viral particles are directed (a) through the inlet into the first compartment and then (b) through the at least one hollow fiber membrane, where the airborne viral particles are captured to produce treated air, and then the treated air is directed (c) through the second compartment before being exhausted from the housing through the outlet.

### RELATED APPLICATIONS

This application claims priority to U.S. Provisional Patent Application Ser. No. 63/337,663, filed on May 3, 2022, the full disclosure of which is hereby incorporated by reference.

### TECHNICAL FIELD

This document relates generally to the field of air remediation and, more particularly, to a new and improved air remediation device and related method of filtering air through a hollow fiber membrane adapted for catching airborne viral particles.

### BACKGROUND

The key role of airborne transmission of COVID-19 in the rapid expansion and widespread nature of the current pandemic has highlighted the need for highly effective, low pressure filter technologies to remove viral aerosols in enclosed indoor environments such as restaurants, offices and hospitals.

### SUMMARY

In accordance with the purposes and benefits described herein, a new and improved air remediation device is provided for an enclosed space. That air remediation device comprises, consists of or consists essentially of at least one hollow fiber membrane module adapted for capturing airborne viral particles. The hollow fiber membrane may be a porous membrane. The hollow fiber membrane may have pores having a diameter of between about 30 nanometers and about 1.4 micrometers.

In at least one of the many possible embodiments, the hollow fiber membrane has an overall porosity of between about 20% and 70%. The hollow fiber membrane may have a thickness of between about 30 micrometers and about 500 micrometers. The hollow fiber membrane may have a tortuosity of between about 1 and 4. In at least some embodiments, the hollow fiber membrane may have pores having a diameter of between about 30 nanometers and about 1.4 micrometers, an overall porosity of between about 20% and 70%, a thickness of between about 30 micrometers and about 500 micrometers, and a tortuosity of between about 1 and 4.

In at least some of the many possible embodiments of the air remediation device, the hollow fiber membrane is made from a material selected from a group consisting of polyvinylidene fluoride, polyvinylidene difluoride, polysulfone, polyethersulfone, poly (methacrylic acid) functionalized polyvinylidene difluoride, poly (methacrylic) functionalized polyamide, poly (methacrylic) functionalized polyimide, poly (methacrylic) functionalized cellulose triacetate, poly (methacrylic acid) functionalized polysulfone, poly (methacrylic acid) functionalized polypropylene, polypropylene, a bio-renewable polymer system and combinations thereof. Biorenewable polymer systems, include, but are not necessarily limited to cellulose, regenerated cellulose, cellulose acetate, cellulose triacetate, lignin sulfonate, and polyester.

In at least some embodiments, the hollow fiber membrane includes pores functionalized with a proteolytic enzyme, an antibody, a nanoparticle and combinations thereof. The proteolytic enzyme may be selected from a group consisting of subtilisin, trypsin, papain, proteinase K, chymotrypsin, elastase and combinations thereof. The antibody and other interacting agents may be selected from a group consisting of a RBD (receptor-binding domain)/ACE2 interaction inhibitor, heparin, glycyrrhizic acid, and combinations thereof. The nanoparticle may be selected from a group consisting of copper nanoparticles, gold nanoparticles, iron nanoparticles, silver nanoparticles and combinations thereof.

In at least some embodiments, a coating of graphene oxide, lignin sulfonate or combinations thereof is provided on the hollow fiber membrane. In at least one of those embodiments, an antiviral agent is provided or included in the coating. That antiviral agent may be selected from a group consisting of a quaternary amine, an essential oil derivative having antiviral properties, copper nanoparticles, gold nanoparticles and combinations thereof.

In accordance with an additional aspect, an air remediation device, comprises, consists of or consists essentially of: a housing including an internal chamber, a potting material dividing the internal chamber into a first compartment and a second compartment and at least one hollow fiber membrane supported by the potting material and held in the first compartment. The at least one hollow fiber membrane is adapted for capturing airborne viral particles. Still further, the air remediation device comprises, consists of or consists essentially of an inlet in communication with the first compartment and an outlet in communication with the second compartment. Untreated air entrained with airborne viral particles is directed (a) through the inlet into the first compartment and then (b) through the at least one hollow fiber membrane, where the airborne viral particles are captured to produce treated air, and then the treated air is directed (c) through the second compartment before being exhausted from the housing through the outlet.

In at least one of the many possible embodiments, the hollow fiber membrane has an overall porosity of between about 20% and 70%. The hollow fiber membrane may have a thickness of between about 30 micrometers and about 500 micrometers. The hollow fiber membrane may have a tortuosity of between about 1 and 4. In at least some embodiments, the hollow fiber membrane may have pores having a diameter of between about 30 nanometers and about 1.4 micrometers, an overall porosity of between about 20% and 70%, a thickness of between about 30 micrometers and about 500 micrometers, and a tortuosity of between about 1 and 4.

In at least some of the many possible embodiments of the air remediation device, the hollow fiber membrane is made from a material selected from a group consisting of polyvinylidene fluoride, polyvinylidene difluoride, polysulfone, polyethersulfone, poly (methacrylic acid) functionalized polyvinylidene difluoride, poly (methacrylic) functionalized polyamide, poly (methacrylic) functionalized polyimide, poly (methacrylic) functionalized cellulose triacetate, poly (methacrylic acid) functionalized polysulfone, poly (methacrylic acid) functionalized polypropylene, polypropylene, a bio-renewable polymer system and combinations thereof. Biorenewable polymer systems, include, but are not necessarily limited to cellulose, regenerated cellulose, cellulose acetate, cellulose triacetate, lignin sulfonate, and polyester.

In at least some embodiments, the hollow fiber membrane includes pores functionalized with a proteolytic enzyme, an antibody, a nanoparticle and combinations thereof. The proteolytic enzyme may be selected from a group consisting of subtilisin, trypsin, papain, proteinase K, chymotrypsin, elastase and combinations thereof. The antibody may be selected from a group consisting of a RBD (receptor-binding domain)/ACE2 interaction inhibitor, heparin, glycyrrhizic acid, and combinations thereof. The nanoparticle may be selected from a group consisting of copper nanoparticles, gold nanoparticles, iron nanoparticles, silver nanoparticles and combinations thereof.

In at least some embodiments, a coating of graphene oxide, lignin sulfonate or combinations thereof is provided on the hollow fiber membrane. In at least one of those embodiments, an antiviral agent is provided or included in the coating. That antiviral agent may be selected from a group consisting of a quaternary amine, an essential oil derivative having antiviral properties, copper nanoparticles, gold nanoparticles and combinations thereof.

In accordance with yet another aspect, a new and improved method of air remediation is provided. That method comprises filtering air through a hollow fiber membrane adapted for capturing airborne viral particles as set forth elsewhere in this document.

In the following description, there are shown and described several different embodiments of the new and improved air remediation device and related method for capturing airborne viral particles. As it should be realized, that device and method are capable of other, different embodiments and their several details are capable of modification in various, obvious aspects all without departing from the device and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein by reference and forming a part of the specification, illustrate several aspects of the new and improved air remediation device and method of air remediation and together with the description serve to explain certain principles thereof.

FIG. 1 is a schematic longitudinal cross sectional view of one possible embodiment of the new air remediation device.

FIG. 2 is a schematic transverse cross sectional view of the embodiment of the air remediation device illustrated in FIG. 1.

FIG. 3 is a schematic illustration of one possible device that may be used to test the air remediation device illustrated in FIGS. 1 and 2.

Reference will now be made in detail to the present preferred embodiments of the air remediation device and the methods related thereto.

### DETAILED DESCRIPTION

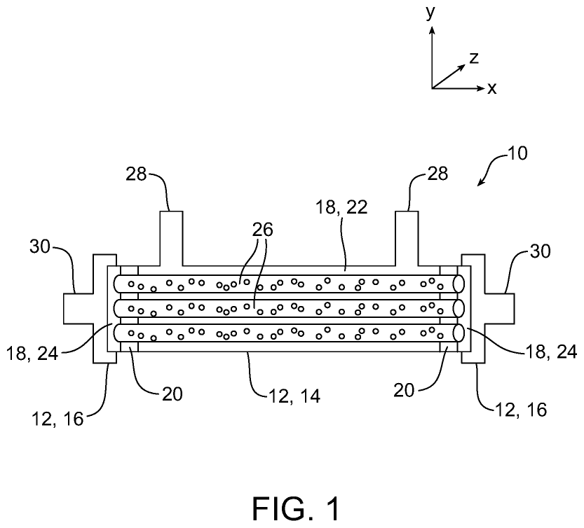

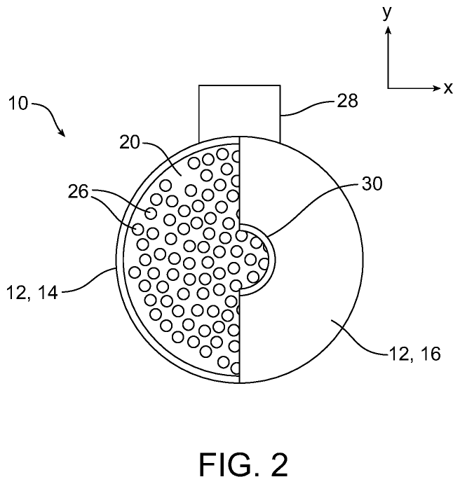

Reference is now made to FIGS. 1 and 2 which illustrated one possible embodiment of a new and improved air remediation device 10 for remediating air of an enclosed space by capturing airborne viral particles. The air remediation device 10 includes a housing 12 having a main body 14 and two end caps 16. The housing includes an internal chamber 18. A potting material 20, of a type known in the art (e.g. an epoxy resin), divides the internal chamber 18 into a first compartment 22 and a second compartment 24. In the illustrated embodiment, the second compartment includes two sections: one adjacent the end cap 16 at each end of the main body 14.

At least one hollow fiber membrane 26 is supported by the potting material 20 in the first compartment 22. An inlet 28 is provided in communication with the first compartment. More specifically, the illustrated embodiment includes two inlets 28 carried on the main body 14. An outlet 30 is provided in communication with the second compartment 24. More specifically, in the illustrated embodiment an outlet 30 is provided in each end cap 16 at each end of the main body 14 so that both sections of the second compartment are in direct communication with an outlet.

In use, untreated air, entrained with airborne viral particles is directed from the enclosed space through the inlet 28 into the first compartment 22. That untreated air is forced through the at least one hollow fiber membrane 26 where the airborne viral particles are captured. The now clean, treated air is directed from the at least one hollow fiber membrane 26 into the second compartment 24 at either end of the device 10 before being exhausted from the outlet 30 back into the enclosed space.

The at least one hollow fiber membrane 26 is a porous membrane. That porous membrane may have pores having a diameter of between about 30 nanometers and about 1.4 micrometers. The at least one hollow fiber membrane 26 may have an overall porosity of between about 20% and 70%. Still further, the at least one hollow fiber membrane may have (a) a thickness of between about 30 micrometers and about 500 micrometers and/or (b) a tortuosity of between about 1 and 4. In one particularly useful embodiment, the hollow fiber membrane may have pores having a diameter of between about 30 nanometers and about 1.4 micrometers, an overall porosity of between about 20% and 70%, a thickness of between about 30 micrometers and about 500 micrometers, and a tortuosity of between about 1 and 4.

The hollow fiber membrane may be made from a material selected from a group consisting of polyvinylidene fluoride, polyvinylidene difluoride, polysulfone, polyethersulfone, poly (methacrylic acid) functionalized polyvinylidene difluoride, poly (methacrylic) functionalized polyamide, poly (methacrylic) functionalized polyimide, poly (methacrylic) functionalized cellulose triacetate, poly (methacrylic acid) functionalized polysulfone, poly (methacrylic acid) functionalized polypropylene, polypropylene, a bio-renewable polymer system and combinations thereof. Biorenewable polymer systems, include, but are not necessarily limited to cellulose, regenerated cellulose, cellulose acetate, cellulose triacetate, lignin sulfonate, and polyester.

The pores of the at least one hollow fiber membrane 26 may be functionalized with a proteolytic enzyme, an antibody, a nanoparticle and combinations thereof. The proteolytic enzyme may be selected from a group consisting of subtilisin, trypsin, papain, proteinase K, chymotrypsin, elastase and combinations thereof. The antibody may be selected from a group consisting of a RBD (receptor-binding domain)/ACE2 interaction inhibitor, heparin, glycyrrhizic acid, and combinations thereof. The nanoparticle may be selected from a group consisting of copper nanoparticles, gold nanoparticles, iron nanoparticles, silver nanoparticles and combinations thereof.

The at least one hollow fiber membrane may further include a coating of graphene oxide, lignin sulfonate or combinations thereof. Still further, the coating may include an antiviral agent. That antiviral agent may be selected from a group consisting of a quaternary amine, an essential oil derivative having antiviral properties, copper nanoparticles, gold nanoparticles and combinations thereof.

Additional details regarding functionalization of hollow fiber membranes disclosed in WO 2021/247720 A1 are incorporated herein by reference.

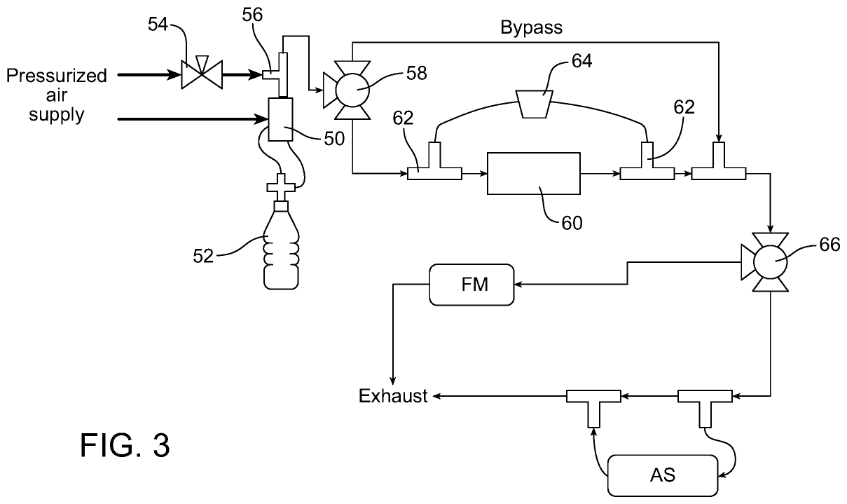

FIG. 3 illustrates one possible embodiment of a device adapted to test the air remediation device of FIGS. 1 and 2 described above. Pressurized air is supplied to an aerosol generator 50 which is fed by a suspension of virus-sized nanoparticles in water 52 to create a humid aerosol stream. A second pressurized air supply, whose flow is controlled by a needle valve 54, is connected to the humid outlet aerosol stream by a tee fitting 56 to control the relative humidity and flow rate of the aerosol stream. The humidity-controlled aerosol stream is fed through a ball valve 58, which can switch the flow of the aerosol stream between: a) the device 60 flanked by tee fittings 62 with an attached differential pressure gauge 64 to determine pressure drop across the device, and b) a bypass for downstream analysis of aerosol concentration fed into the device 60. The aerosol stream (after passing through the device or the bypass connection) is passed through a second ball valve 66), which can switch the flow between: a) flow meter (FM) for analyzing the volume of processed air per time, and b) an aerosol spectrometer (AS) that measures the concentration and size distribution of aerosol particles in the air stream that has passed through either the bypass or the device. The ability of the device to remove virus-sized aerosol particles is measured by comparison of the aerosol particle concentrations in the unprocessed (ball valve 58 set to bypass) versus the processed (ball valve 58 set to flow through the device 60 air stream.

This disclosure may be said to relate to the following items:
1. An air remediation device for an enclosed space, comprising: at least one hollow fiber membrane module adapted for capturing airborne viral particles.
2. An air remediation device, comprising:
   a housing including an internal chamber;
   a potting material dividing said internal chamber into a first compartment and a second compartment;
   at least one hollow fiber membrane supported by the potting material and held in the first compartment, said at least one hollow fiber membrane being adapted for capturing airborne viral particles;
   an inlet in communication with the first compartment; and
   an outlet in communication with the second compartment whereby untreated air entrained with airborne viral particles is directed (a) through the inlet into the first compartment and then (b) through the at least one hollow fiber membrane, where the airborne viral particles are captured to produce treated air, and then the treated air is directed (c) through the second compartment before being exhausted from the housing through the outlet.
3. The air remediation device of item 2, wherein the hollow fiber membrane is a porous membrane.
4. The air remediation device of item 3, wherein the hollow fiber membrane has pores having a diameter of between about 30 nanometers and about 1.4 micrometers.
5. The air remediation device of item 3, wherein the hollow fiber membrane has an overall porosity of between about 20% and 70%.
6. The air remediation device of item 3, wherein the hollow fiber membrane has a thickness of between about 30 micrometers and about 500 micrometers.
7. The air remediation device of item 3, wherein the hollow fiber membrane has a tortuosity of between about 1 and 4.
8. The air remediation device of item 3, wherein the hollow fiber membrane has pores having a diameter of between about 30 nanometers and about 1.4 micrometers, an overall porosity of between about 20% and 70%, a thickness of between about 30 micrometers and about 500 micrometers, and a tortuosity of between about 1 and 4.
9. The air remediation device of item 8, wherein the hollow fiber membrane is made from a material selected from a group consisting of polyvinylidene fluoride, polyvinylidene difluoride, polysulfone, polyethersulfone, poly (methacrylic acid) functionalized polyvinylidene difluoride, poly (methacrylic) functionalized polyamide, poly (methacrylic) functionalized polyimide, poly (methacrylic) functionalized cellulose triacetate, poly (methacrylic acid) functionalized polysulfone, poly (methacrylic acid) functionalized polypropylene, polypropylene, a bio-renewable polymer system (cellulose, regenerated cellulose, cellulose acetate, cellulose triacetate, lignin sulfonate, and polyester), and combinations thereof.
10. The air remediation device of item 9, wherein the hollow fiber membrane includes pores functionalized with a proteolytic enzyme, an antibody, a nanoparticle and combinations thereof.
11. The air remediation device of item 10, wherein the proteolytic enzyme is selected from a group consisting of subtilisin, trypsiniron, papain, proteinase K, chymotrypsin, elastase and combinations thereof.
12. The air remediation device of item 10, wherein the antibody is selected from a group consisting of a RBD (receptor-binding domain)/ACE2 interaction inhibitor, heparin, glycyrrhizic acid, and combinations thereof
13. The air remediation device of item 10 wherein the nanoparticle is selected from a group consisting of copper nanoparticles, gold nanoparticles, iron nanoparticles, silver nanoparticles and combinations thereof
14. The air remediation device of item 10, further including a coating of graphene oxide, lignin sulfonate or combinations thereof on the hollow fiber membrane.
15. The air remediation device of item 14, further including an antiviral agent in the coating.
16. The air remediation device of item 15, wherein the antiviral agent is selected from a group consisting of a quaternary amine, an essential oil derivative having antiviral properties, copper nanoparticles, gold nanoparticles and combinations thereof.
17. The air remediation device of item 2, further including a coating of graphene oxide, lignin sulfonate or combinations thereof on the hollow fiber membrane.
18. The air remediation device of item 17, further including an antiviral agent in the coating.
19. The air remediation device of item 18, wherein the antiviral agent is selected from a group consisting of a quaternary and primary amines, an essential oil derivative having antiviral properties, copper nanoparticles, gold nanoparticles and combinations thereof.
20. A method of air remediation, comprising filtering air through a hollow fiber membrane adapted for catching airborne viral particles as set forth in any of items 1-19.

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an antibody”, as used herein, may also refer to, and encompass, a plurality of antibodies and other interacting agents.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the air remediation device and the method or process for air remediation of this disclosure have been illustratively described and presented by way of specific exemplary embodiments, and examples thereof, it is evident that many alternatives, modifications, or/and variations, thereof, will be apparent to those skilled in the art. For example, the flow of air may be reversed through the air remediation device so that the inlets become the outlets and the outlets become the inlets. Accordingly, it is intended that all such alternatives, modifications, or/and variations, fall within the spirit of, and are encompassed by, the broad scope of the appended claims.

What is claimed:

1. An air remediation device for an enclosed space, comprising: at least one hollow fiber membrane module adapted for capturing airborne viral particles.

2. An air remediation device, comprising:
a housing including an internal chamber;
a potting material dividing said internal chamber into a first compartment and a second compartment;
at least one hollow fiber membrane supported by the potting material and held in the first compartment, said at least one hollow fiber membrane being adapted for capturing airborne viral particles;
an inlet in communication with the first compartment; and
an outlet in communication with the second compartment whereby untreated air entrained with airborne viral particles is directed (a) through the inlet into the first compartment and then (b) through the at least one hollow fiber membrane, where the airborne viral particles are captured to produce treated air, and then the treated air is directed (c) through the second compartment before being exhausted from the housing through the outlet.

3. The air remediation device of claim 2, wherein the hollow fiber membrane is a porous membrane.

4. The air remediation device of claim 3, wherein the hollow fiber membrane has pores having a diameter of between about 30 nanometers and about 1.4 micrometers.

5. The air remediation device of claim 3, wherein the hollow fiber membrane has an overall porosity of between about 20% and 70%.

6. The air remediation device of claim 3, wherein the hollow fiber membrane has a thickness of between about 30 micrometers and about 500 micrometers.

7. The air remediation device of claim 3, wherein the hollow fiber membrane has a tortuosity of between about 1 and 4.

8. The air remediation device of claim 3, wherein the hollow fiber membrane has pores having a diameter of between about 30 nanometers and about 1.4 micrometers, an overall porosity of between about 20% and 70%, a thickness of between about 30 micrometers and about 500 micrometers, and a tortuosity of between about 1 and 4.

9. The air remediation device of claim 8, wherein the hollow fiber membrane is made from a material selected from a group consisting of polyvinylidene fluoride, polyvinylidene difluoride, polysulfone, polyethersulfone, poly (methacrylic acid) functionalized polyvinylidene difluoride, poly (methacrylic) functionalized polyamide, poly (methacrylic) functionalized polyimide, poly (methacrylic) functionalized cellulose triacetate, poly (methacrylic acid) functionalized polysulfone, poly (methacrylic acid) functionalized polypropylene, polypropylene, a bio-renewable polymer system and combinations thereof.

10. The air remediation device of claim 9, wherein the hollow fiber membrane includes pores functionalized with a proteolytic enzyme, an antibody, a nanoparticle and combinations thereof.

11. The air remediation device of claim 10, wherein the proteolytic enzyme is selected from a group consisting of subtilisin, trypsiniron, papain, proteinase K, chymotrypsin, elastase and combinations thereof.

12. The air remediation device of claim 10, wherein the antibody is selected from a group consisting of a RBD (receptor-binding domain)/ACE2 interaction inhibitor, heparin, glycyrrhizic acid, and combinations thereof.

13. The air remediation device of claim 10 wherein the nanoparticle is selected from a group consisting of copper nanoparticles, gold nanoparticles, iron nanoparticles, silver nanoparticles and combinations thereof.

14. The air remediation device of claim 10, further including a coating of graphene oxide, lignin sulfonate or combinations thereof on the hollow fiber membrane.

15. The air remediation device of item 14, further including an antiviral agent in the coating.

16. The air remediation device of claim 15, wherein the antiviral agent is selected from a group consisting of a quaternary amine, an essential oil derivative having antiviral properties, copper nanoparticles, gold nanoparticles and combinations thereof.

17. The air remediation device of claim 2, further including a coating of graphene oxide, lignin sulfonate or combinations thereof on the hollow fiber membrane.

18. The air remediation device of claim 17, further including an antiviral agent in the coating.

19. The air remediation device of claim 18, wherein the antiviral agent is selected from a group consisting of a quaternary and primary amines, an essential oil derivative having antiviral properties, copper nanoparticles, gold nanoparticles and combinations thereof.

20. A method of air remediation, comprising filtering air through a hollow fiber membrane adapted for catching airborne viral particles as set forth in claim 2.
